(19) United States
(12) Patent Application Publication
(10) Pub. No.: US 2017/0003677 A1
(43) Pub. Date: Jan. 5, 2017

(54) Real Time Monitoring System and Method Thereof of Optical Film Manufacturing Process

(71) Applicant: Yuan Ze University, Taoyuan City (TW)

(72) Inventors: Chia-Yu HSU, New Taipei City (TW); Ting-Ying CHIEN, Taoyuan City (TW); Kuo-Hua LAI, Taoyuan City (TW); Chien-Lung CHAN, Taoyuan City (TW)

(21) Appl. No.: 14/970,262

(22) Filed: Dec. 15, 2015

(30) Foreign Application Priority Data
Jul. 3, 2015 (TW) 104121759

(51) Int. Cl. G05B 19/418; G01N 21/95

(52) U.S. Cl. CPC G05B 19/41875; G01N 21/95; G05B 2219/37042; G05B 2219/32368

(57) ABSTRACT

A real time monitoring system and a method thereof of an optical film manufacturing process are provided. The real time monitoring system includes a plurality of production systems and a cloud big data platform which connects to the plurality of production systems. The process data of the production line is collected by as production line data collector of the production system. The process data is uploaded to a database of the cloud big data platform. The historical process data across the plurality of production systems can be combined as a process waveform feature by a profile database. A processor connects to the database and the profile database. The differences between the process data and the process waveform feature are compared in real time. When the difference value exceeds a threshold value, an abnormal message is sent to the corresponding production line.

### CROSS-REFERENCE TO RELATED APPLICATION

This application claims priority from Taiwan Patent Application No. 104121759, filed on Jul. 3, 2015, in the Taiwan Intellectual Property Office, the content of which is hereby incorporated by reference in their entirely for all purposes.

### BACKGROUND OF THE INVENTION

1. Field of the Invention

This application relates to a real time monitoring system and a method thereof of an optical film manufacturing process, and more particularly, to a real time monitoring system and a method thereof of an optical film manufacturing process applying the process data of the optical film across a plurality of production systems integrated in a cloud big data platform to real time compare with the process data detected from the production lines, so as to effectively monitor the manufacturing process of the optical film.

2. Description of the Related Art

Conventionally, it has to detect whether the product quality is satisfied with the standards when the entire manufacturing process of the optical film is completed, so that the product can be delivered to the client. When the quality control personnel find the defective items, the products are usually in back-end of the manufacturing process. As a result. it is too late to know that quite a few defective items, either of the final product and the semi-manufactured product, are produced in the front-end or the back-end of the manufacturing process regardless. So, discarding those defective items causes the loss costs seriously and also reduces the yield rate greatly. Consequently, the production efficiency is affected so as to lead to a huge increase of the manufacturing cost.

In addition, when the defective items are found by the quality control personnel, the reason causing the defect cannot be found out instantly as the entire manufacturing process has been completed. So, it has to stop the whole production line to find out which production machine is in an abnormal state, so that the entire production line can be restarted. In such case, it costs time and causes a loss of human resource, and the idle machines have lower production capacity. The entire production line is therefore affected by the testing time before the production line is restarted.

Furthermore, the optical film manufacturing process is different from the production of electronic components. The optical film has a finite production quantity and the process data classified by the model numbers and the types are also limited, and thus, the comparison data applied to determine the abnormality is relatively not many under such circumstances even though the machine has setting problems or the detection state thereof is unstable; the operating personnel are not able to find out where the problem goes as a lack of the related data. Because a critical moment of finding out the defective items and dealing with the situation is missed, reworking or reproducing becomes impossible and it therefore results in loss costs and unnecessary waste of resource.

In view of this, how to design a real-time monitoring system and method of the optical film manufacturing process, so that the manufacturing process proceeds to instantly monitor the quality of products, improve production yield and reduce waste costs, would be desirable to reach by the manufacturers. Thus, the inventor thinking and design a real-time monitoring system of the optical film manufacturing process and a method thereof for improving the existing shortcomings so as to improve the industrial practicability.

### SUMMARY OF THE INVENTION

In view of the aforementioned technical problems, the primary objective of the present disclosure provides a real time monitoring system and a method thereof of an optical film manufacturing process which aims at resolving the technical problems of time and cost consuming and being unable to obtain the cause of the defect.

According to one objective of the present disclosure, it provides a real time monitoring system of an optical film manufacturing process, which may include a plurality of production systems respectively disposed in different positions, and a cloud big data platform connected to the plurality of production systems through an internet connection. The plurality of production systems respectively include a production line disposed with a plurality of production machines for manufacturing an optical film, a detector disposed on each of the plurality of production machines for real time monitoring process data of the plurality of production machines, and a production line data collector connected to the detector through an IoT (Internet of Things) connection to receive the process data detected by the detector. The cloud big data platform includes a database, a profile database connected to the database and a processor connected to the database and the profile database. The database stores the process data uploaded by the production line data collector of the plurality of production machines. The profile database combines historical process data across the plurality of production lines produced in a normal production state stored in the database to form a process waveform feature. The processor fills gaps of the process data to form a complete waveform diagram by an interpolation method and compares discrepant data between the complete waveform diagram and the process waveform feature in real time, and when the discrepant data exceed in a threshold value, the processor transmitting an exception message to the production line corresponding to the process data.

Preferably, the process data may include a machine setting parameter, a machine state parameter, a raw material process state or a work-in-process process state.

Preferably, each of the plurality of production lines may further be disposed with an automatic optical detector to detect an image of the optical film and to transmit the image to the production line data collector through the IoT connection.

Preferably, the profile database may include a machine learning assembly. The process data detected from the same optical manufacturing process across the plurality of production lines is updated to accordingly update the process waveform feature.

Preferably, the process data may be classified as an arborescence including a plurality of influence parameters according to a decision tree algorithm, and when the discrepant data exceed in the threshold value, the production machine which is in an abnormal state is determined according to a position in which the plurality of influence parameters produce the discrepant data.

According to another objective of the present disclosure, it provides a real time monitoring method of an optical film manufacturing process applied to a plurality of production systems of different positions, the plurality of production systems respectively including a production line, the production line disposed with a plurality of production machines to manufacture optical films, and the real time monitoring method of the optical film manufacturing process may include the following steps: real time monitoring process data of the plurality of production machines by a detector disposed on each of the plurality of production machines; transmitting the process data to a production line data collector of the plurality of production systems through an IoT connection; connecting the production line data collector of the plurality of production systems to a cloud big data platform and uploading the monitored process data to a database of the cloud big data platform by an internet connection; combining historical process data across the plurality of production lines produced in a normal production state stored in the database to form a process waveform feature and storing the process waveform feature in a profile database connected to the database, filling gaps of the process data by an interpolation method to form a complete waveform diagram by a processor, and comparing discrepant data between the complete waveform diagram and the process waveform feature stored in the profile database in real time by the processor, and when the discrepant data exceed in a threshold value, transmitting an exception message to the production line corresponding to the process data by the processor.

Preferably, the process data may include a machine setting parameter, a machine state parameter, a raw material process state or a work-in-process process state.

Preferably, detecting the process data of the plurality of production machines may further include the following step: detecting an image of the optical film by an automatic optical detector disposed on each of the plurality of production machines and transmitting the image to the production line data collector through the IoT connection.

Preferably, the profile database may include a machine learning assembly updating the process data detected from the same optical manufacturing process across the plurality of production lines to accordingly update the process waveform feature.

Preferably, the process data may be classified as an arborescence including a plurality of influence parameters according to a decision tree algorithm, and when the discrepant data exceed in the threshold value, the production machine which is in an abnormal state is determined according to a position in which the plurality of influence parameters produce the discrepant data.

As mentioned previously, a real time monitoring system and method thereof of optical film manufacturing process of the present disclosure may have one or more advantages as follows.

1. A real time monitoring system and a method thereof of an optical film manufacturing process of the present disclosure can integrate the process data of different production lines of a plurality of production systems to combine the process data having the same manufacturing process, so as to form a complete process waveform feature. As a result, the accuracy of comparing the real-time data is increased.

2. A real time monitoring system and as method thereof of an optical film manufacturing process of the present disclosure can synchronously monitor the process parameter and then transmit the detected data to the cloud big platform through the IoT connection or internet for being analyzed and comparing, such that the state of manufacturing process can be monitored instantaneously. In addition, when abnormal situation occurs, the staff can deal with it as soon as possible to avoid the product having the same shortcoming repeatedly as well as causing the waste of production cost, so as to promote the yield rate of the optical film manufacturing process.

3. A real time monitoring system and as method thereof of an optical film manufacturing process of the present disclosure apply the decision tree algorithm to find out the production line and machine occurring abnormal parameter to quickly adjust the parameter of the machine occurring abnormal parameter or adjust the state of production. Consequently, the time for improving can be decreased and the production efficiency of the production line is promoted.

### BRIEF DESCRIPTION OF THE DRAWINGS

FIG. 1 is a schematic diagram of a real time monitoring system of an optical film manufacturing process of the present disclosure.

FIG. 2 is a schematic diagram of a cloud big data platform of the present disclosure.

FIG. 3 is a flow chart of a real time monitoring method of an optical film manufacturing process of the present disclosure.

FIG. 4 is a schematic diagram of applying an interpolation method to fill the process waveform feature of the present disclosure.

FIG. 5 is a schematic diagram of a decision tree algorithm of the present disclosure.

FIG. 6 is a waveform diagram of an abnormal equipment data of the present disclosure.

### DETAILED DESCRIPTION OF THE PREFERRED EMBODIMENTS

Hereinafter, embodiments of the present disclosure will be described in detail with reference to the accompanying drawings so that those skilled in the art to which the present disclosure pertains can realize the present disclosure. The exemplary embodiments of the present disclosure will be understood more fully from the detailed description given below and from the accompanying drawings of various embodiments of the disclosure, which, however, should not be taken to limit the disclosure to the specific embodiments, but are for explanation and understanding only.

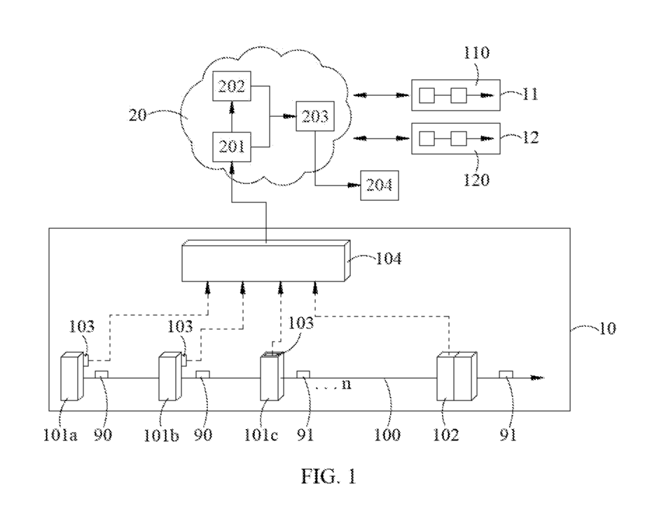

Please refer to FIG. 1 which is a schematic diagram of a real time monitoring system of an optical film manufacturing process of the present disclosure. As shown in the figure, a real time monitoring system of an optical film manufacturing process includes a first production system 10, a cloud big data platform 20, a second production system 11 and a third production system 12. The first production system 10, the second production system 11 and the third production system 12 are disposed in different factories which are neighbor with each other, and alternatively, are disposed in different cities or countries. The present embodiment applies three production systems as an exemplary aspect, but it shall be not limited thereto. The amount of production systems may be decided according to the scale of respective enterprises. Take the first production system 10 for example. When the first production system 10 is provided with a first production line 100, the first production line 100 is disposed with a first production machine 101a, a second production machine 101b, a third production machine 101c to a n^{th} production machine 101a. The production machine mentioned herein, which may include injection molding machine, compression molding machine, optical coating machine, exposure developing machine, etching machine, cutting machine, bonding machine, roasting machine, and so on, is decided according to the requirements of types, materials . . . etc. for the optical film. Various optoelectronic materials are delivered to production machines to be manufactured from a work-in-process 90 to an optical film 91. Afterwards, the optical film 91 is shipped to the client before being examined by an automated optical inspection (AOI) 102. It is similar to the first production line 10, the second production system 11 and the third production system 12 also include a second production line 110 and a third production line 120, and the configuration of the second production line 110 and the third production line 120 are similar to that of the first production line 100. However, the production line mentioned herein is not limited to a single production line. Each production system may also be disposed with multiple production lines for simultaneously manufacturing the necessary optical film or different types of optical film. The optical film mentioned herein is an optical diffusion sheet which is feasible to be applied to a backlight module of TFT-LCD or cover of illumination lamp.

Here, the first production system 10 is applied as an example again. The first production machine 101a, the second production machine 101b, and the third production machine 101c mentioned above indicate different manufacturing processes of optical film. As to the operation of the production machines, each of the production machines has the setting parameter and machine state, respectively. So, a detector 103 is disposed on each production machine to detect process data of each machine, and the detector 103 is connected to a production line data collector 104 through the IoT connection, such that the detected data can be transmitted to the production line data collector 104. Then, the data are integrated and uploaded to a cloud big data platform 20. The detector 103 mentioned herein may be a transmission device which transmits the machine parameters set by the machine operating personnel. The machine parameters may be heating time, feeding rate, and so on. Alternatively, the detector 103 may be sensing device which senses the machines or the treatment of optical film, such as temperature and consistence of material. Similarly, the parameters are transmitted to the production line data collector 104. In addition, the automated optical inspection 102 detects an image of the optical film 91 and transmits the image information to the production line data collector 104 to be collected together.

The process data detected by the production machines and the automated optical inspection 102 are collected by the production line data collector 104 and then uploaded to the cloud big data platform 20 through the interne connection. Each production system is connected to the cloud big data platform 20 through an on-line server. When the process is performing, the data which are simultaneously uploaded, are applied to monitor the state of the production line. Here, the uploaded data are all stored in a database 201. The data encompass all the production systems. The production line data related to the optical film manufacturing factories built by the same enterprise or group are all transmitted to the database 201 to be stored. Most of the process data stored in the database 201 are historical process data recorded under normal condition. The historical process data are combined in a profile database 202 which is connected to the database 201 to be transformed into a process waveform feature. Each process of manufacturing the product has respective process waveform features. When the detected process data are transmitted to the database, a processor 203 of the cloud big data platform 20 compares the real-time process data with the process waveform feature to calculate the difference therebetween. When discrepant data exceed in a predetermined threshold value, such process is determined in an abnormal condition. The processor 203 further transmits an exception message 204 to the corresponding production line or production machine to notify the manager to deal with the abnormal condition as soon as possible.

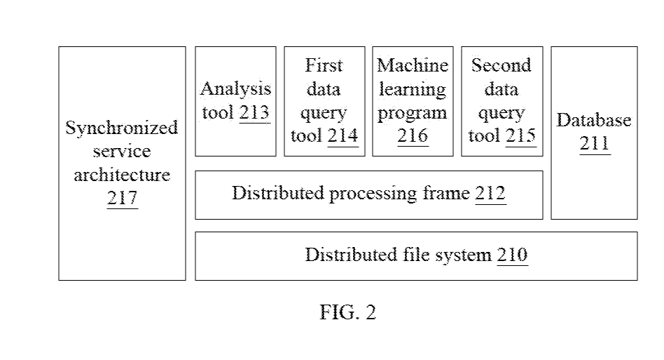

Please refer to FIG. 2 which is a schematic diagram of a cloud big data platform of the present disclosure. As shown in the figure, the cloud big data platform 20 of the present embodiment is designed to include a module including a distributed file system 210, a database 211, a distributed processing frame 212, an analysis tool 213, a first data query tool 214, a second data query tool 215, a machine learning program 216 and a synchronized service architecture 217. The distributed file system 210 may be a Hadoop Distributed File System (HDFS) which integrates the distributed stored data into a storage space characterized of fault tolerance, high efficiency and large capacity. The database 211, which is arranged on the distributed file system 210, is a distributed database, such as HBase. The distributed processing frame 212 is feasible for the developer to write program, use a great amount of calculation resource, and quicken processing enormous data quantity, such as YARN Map Reduce v2. The analysis tool 213 applied herein is to use R connector. Module of the first data query tool 214 may be Impala and the second data query tool 215 may be Hive. The programming tools including SQL query language, and so on. Besides, the cloud big data platform further includes the machine learning program 216 which fills the gaps of the process waveform feature or updates the erroneous parts, such that the waveform diagram of the process waveform feature is more completed. Finally, collaborative services architecture 217 may provide decentralized application of the original instructions, such Zookeper.

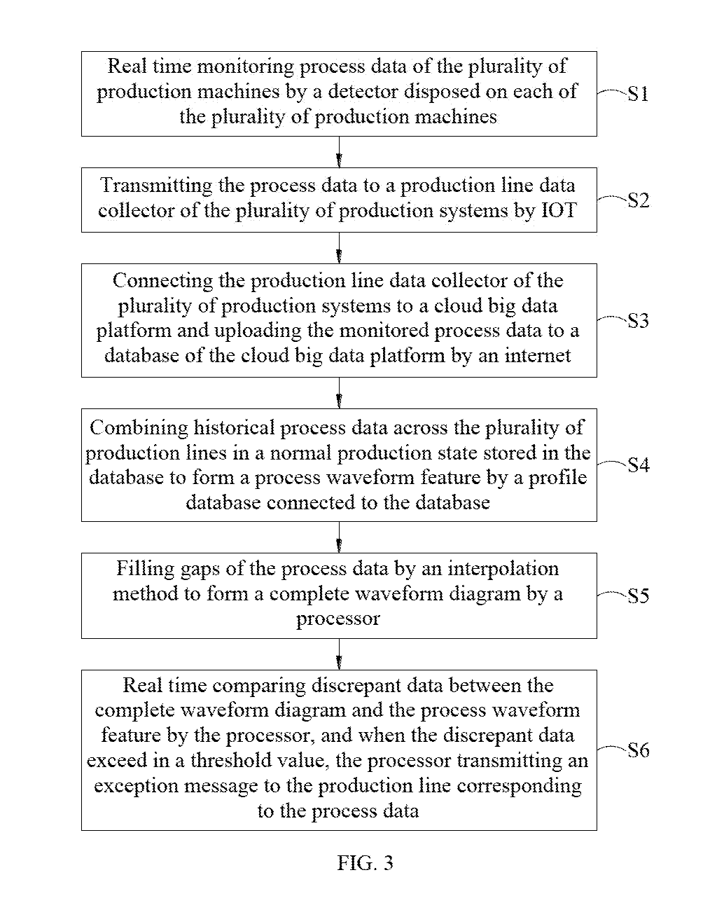

Please refer to FIG. 3 which is a flow chart of a real time monitoring method of an optical film manufacturing process of the present disclosure. The real time monitoring method of an optical film manufacturing process aims at instantaneously monitoring production systems disposed at different locations. At this moment, each production system is provided with one or more production lines, and each production line is disposed with production machine for manufacturing optical film according to the actual requirements. The real time monitoring method of an optical film manufacturing process can be referred to the following steps S1 to S6 as shown in the figure.

Step S1: real time monitoring process data of a plurality of production machines by a detector disposed on each of the plurality of production machines. As mentioned above, each production machine is disposed with a detector or a transmitter thereupon. The detector or the transmitter is applied to detect or obtain process data including a machine setting parameter, a machine state parameter, a raw material process state or a work-in-process process state.

Step S2: transmitting the process data to a production line data collector disposed on each of the plurality of production systems by an IoT connection. The detector is connected to the production line data collector through the IoT connection, and the production line data collector is disposed on each production line or in each production system to receive the process data transmitted by the detector disposed on each production line.

Step S3: connecting the production line data collector disposed on each of the plurality of production systems to a cloud big data platform and uploading the monitored process data to a database of the cloud big data platform by an internet connection. The interne connection of each factory is connected, such that the production line data collector is connected to the cloud big data platform and the data are uploaded to the database. The uploaded data mentioned herein means the process data across all the related production systems. Consequently, an enormous data are stored in the database for the follow-up comparison and analysis.

Step S4: combining historical process data across the plurality of production lines in a normal production state stored in the database to form a process waveform feature by a profile database connected to the database. Because the enormous process data stored in the database are compared effectively, the profile database is disposed in advance to store the compiled historical process data. Such historical process data is mainly served as a comparison standard for the follow-up real time monitor. In the present embodiment, each detected process data are transformed into a waveform diagram corresponding to the time series, so that each parameter produces the specific process waveform feature. When the real-time information of the same parameter is obtained, it can be applied to compare with the waveform feature.

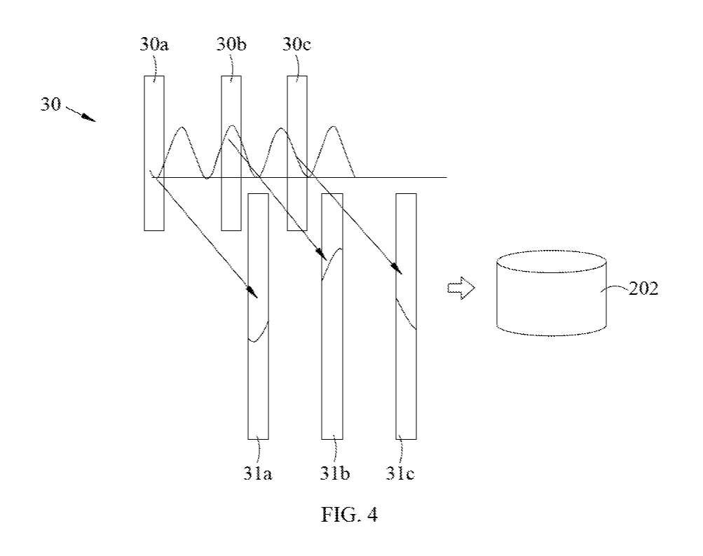

Step S5: filling gaps of the process data by an interpolation method to form a complete waveform diagram by a processor. Here, please refer to FIG. 4 which is a schematic diagram of applying an interpolation method to fill the process data of the present disclosure. As shown in the figure, the enormous process data in the database are categorized based on material types of the optical film, such that each parameter of the process data is transformed into a process waveform feature 30 as shown in the figure. The process waveform feature 30 is the waveform diagram relative to the time series. As mentioned previously, the optical film manufacturing process has limited production quantity, so the waveform diagram may have gaps 30a, 30b, 30c after the process data are collected. Here, if the detected process data, have such gaps, the known comparison is incapable of finding out the difference. So, in present embodiment, the interpolation method is applied to fill the gaps 30a, 30b, 30c in the waveform diagram, so that the process waveform feature 30 becomes a complete waveform diagram. As a result, whether the detected data is detected in which time it can be compared to be determined if there is an abnormal condition.

Step S5: real time comparing discrepant data between the complete waveform diagram and the process waveform feature by the processor, and when the discrepant data exceed in a threshold value, the processor transmitting, an exception message to the production line corresponding to the process data. As the aforementioned profile database 202 has stored the process waveform feature, the following formula (1) is applied to calculate compared discrepant data of the process data derived from the real time monitoring after the process data is uploaded.

D=\sqrt{(a₁−b₁)²+(a₂−b₂)²+ . . . +(aₙ−bₙ)²} (1)

Here, D is the compared discrepant data, aₙ is the data derived from the real time monitoring, and bₙ is the data of the process waveform feature stored in the profile database.

When the compared discrepant data is obtained, it is further compared with the threshold value T. If D>T, the exception message is transmitted to the production line corresponding to the process data to notify the operating personnel to deal the abnormal situation. Here, the threshold value T is a predetermined value, and it can be adjusted according to the actual requirements.

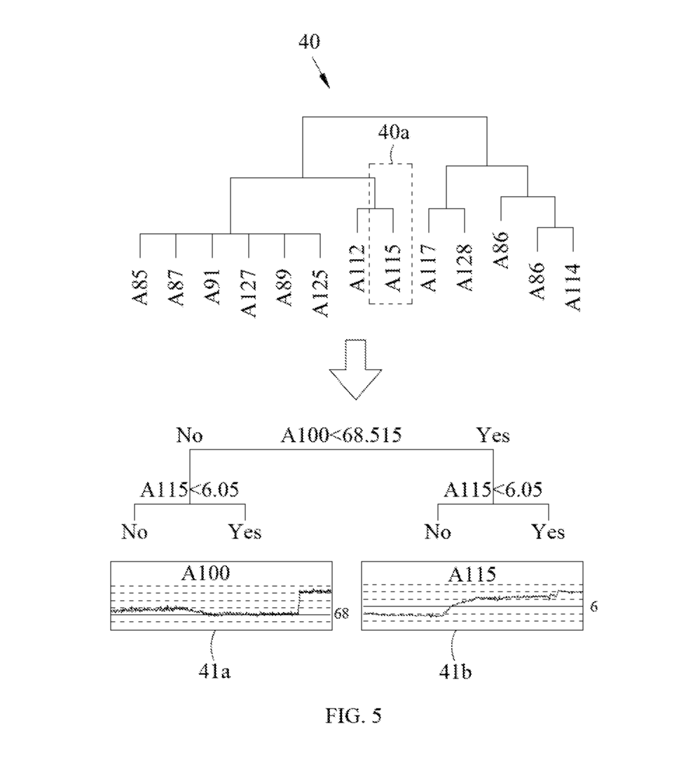

Please refer to FIG. 5 which is a schematic diagram of a decision tree algorithm of the present disclosure. As shown in the figure, when the difference between process data and the process waveform feature is obtained, the system transmits related information to the staff. Consequently, a decision tree algorithm is applied to find out the position where the parameter has problem. In the figure, the optical film manufacturing process region is divided into parameters by A1 to A200, and each parameter indicates different features, such as temperature, consistency, pressure, flow, rotation speed of machine, and so on. The figure also demonstrates that a decision tree 40 is a tree structure showing the parameters with respect to the specific machine. So, when the process waveform feature occurs abnormal situation, for example, the waveform diagram 41a of the compared discrepant data with the parameter A100 and the waveform diagram 41b of the compared discrepant data with the parameter A115 occurring obvious abnormal situation, it can instantly find out the machine corresponding to the parameters A100 and A115 of the decision tree 40, such that the reason for the abnormal situation is determined according to a tree structure relationship 40a. When transmitting the exception message, it synchronously notifies the operating personnel to adjust the machine parameter or the related setting as soon as possible, so as to resolve the deficiency and promote the yield rate. As a result, the whole production efficiency thereby is boosted.

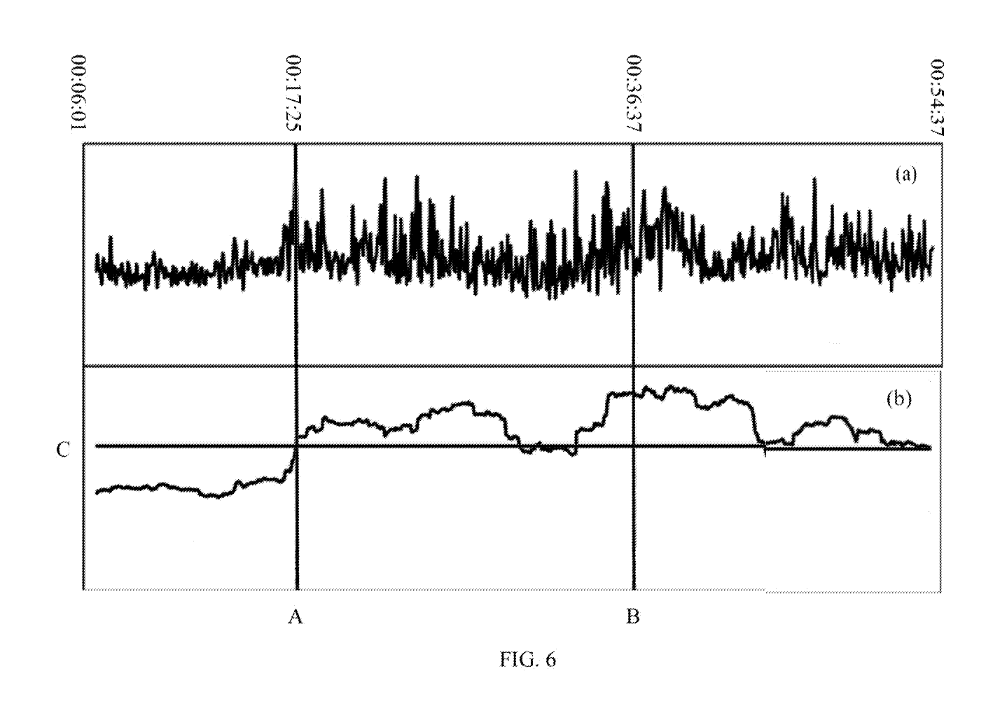

Please refer to FIG. 6 which is a waveform diagram of an abnormal equipment data of the present disclosure. The waveform diagram (a) shows the sensor data detected by the detector and the waveform diagram (b) shows the compared discrepant data calculated by formula (1). As shown in the figure, an example that the abnormal signal (a high pick) started at time line A, as the discrepant data is larger than the threshold value (line C). The exception message is synchronously sent to the operating personnel for solving the abnormal situation. Relatively, the original AOI device reports the defects at time line B, which is late for 20 minutes. The reaction time of product, the abnormal equipment data occurrence early than AOI report defect. The real time monitoring method of an optical film manufacturing process is achieved and the abnormal signal is generated earlier. The equipment engineer can repair the error immediately and reduce the cost lost in this period.

While the means of specific embodiments in present disclosure has been described by reference drawings, numerous modifications and variations could be made thereto by those skilled in the art without departing from the scope and spirit of the disclosure set forth in the claims. The modifications and variations should in a range limited by the specification of the present disclosure.

What is claimed is:

1. A real time monitoring system of an optical film manufacturing process, comprising:
a plurality of production systems respectively disposed in different positions, and the plurality of production systems respectively comprising:
a production line disposed with a plurality of production machines for manufacturing an optical film, a detector disposed on each of the plurality of production machines for real time monitoring process data of the plurality of production machines; and
a production line data collector connected to the detector through an IoT connection to receive the process data detected by the detector;
a cloud big data platform connected to the plurality of production systems through an internet connection, and the cloud big data platform comprising:
a database storing the process data uploaded by the production line data collector of the plurality of production machines;
a profile database connected to the database combining historical process data across the plurality of production lines produced in a normal production state stored in the database to form a process waveform feature; and
a processor connected to the database and the profile database filling gaps of the process data to form a complete waveform diagram by an interpolation method and comparing discrepant data between the complete waveform diagram and the process waveform feature in real time, and when the discrepant data exceed in a threshold value, the processor transmitting an exception message to the production line corresponding to the process data.

2. The real time monitoring system of the optical film manufacturing process of claim 1, wherein the process data comprises a machine setting parameter, a machine state parameter, a raw material process state or a work-in-process process state.

3. The real time monitoring system of the optical film manufacturing process of claim 1, wherein each of the plurality of production lines is further disposed with an automatic optical detector to detect an image of the optical film and to transmit the image to the production line data collector through the IoT connection.

4. The real time monitoring system of the optical film manufacturing process of claim 1, wherein the profile database comprises a machine learning assembly updating the process data detected from the same optical manufacturing process across the plurality of production lines to accordingly update the process waveform feature.

5. The real time monitoring system of the optical film manufacturing process of claim 1, wherein the process data are classified as an arborescence comprising a plurality of influence parameters according to a decision tree algorithm, and when the discrepant data exceed in the threshold value, the production machine which is in an abnormal state is determined according to a position in which the plurality of influence parameters produce the discrepant data.

6. A real time monitoring method of an optical film manufacturing process applied to a plurality of production systems of different positions, the plurality of production systems respectively comprising a production line, the production line disposed with a plurality of production machines to manufacture optical films, and the real time monitoring method of the optical film manufacturing process comprising the following steps:
real time monitoring process data of the plurality of production machines by a detector disposed on each of the plurality of production machines;
transmitting the process data to a production line data collector of the plurality of production systems through an IoT connection;
connecting the production line data collector of the plurality of production systems to a cloud big data platform and uploading the monitored process data to a database of the cloud big data platform by an internet connection;
combining historical process data across the plurality of production lines produced in a normal production state stored in the database to form a process waveform feature and storing the process waveform feature in a profile database connected to the database,
filling gaps of the process data by an interpolation method to form a complete waveform diagram by a processor; and
comparing discrepant data between the complete waveform diagram and the process waveform feature stored in the profile database in real time by the processor, and when the discrepant data exceed in a threshold value, transmitting an exception message to the production line corresponding to the process data by the processor.

7. The real time monitoring method of the optical film manufacturing process of claim 6, wherein the process data comprises a machine setting parameter, a machine state parameter, a raw material process state or a work-in-process process state.

8. The real time monitoring method of the optical film manufacturing process of claim 6, wherein detecting the process data of the plurality of production machines further comprises the following step:
detecting an image of the optical film by an automatic optical detector disposed on each of the plurality of production machines and transmitting the image to the production line data collector through the IoT connection.

9. The real time monitoring method of the optical film manufacturing process of claim 6, wherein the profile database comprises a machine learning assembly updating the process data detected from the same optical manufacturing process across the plurality of production lines to accordingly update the process waveform feature.

10. The real time monitoring method of the optical film manufacturing process of claim 6, wherein the process data are classified as an arborescence comprising a plurality of influence parameters according to a decision tree algorithm, and when the discrepant data exceed in the threshold value, the production machine which is in an abnormal state is determined according to a position in which the plurality of influence parameters produce the discrepant data.
